(19) United States
(12) Patent Application Publication
(10) Pub. No.: US 2008/0195860 A1
(43) Pub. Date: Aug. 14, 2008

(54) METHOD AND APPARATUS FOR DETECTING A COMPROMISED NODE IN A NETWORK

(75) Inventors: Anand S. Bedekar, Arlington Heights, IL (US); Rajeev Agrawal, Northbrook, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/674,752

(22) Filed: Feb. 14, 2007

(51) Int. Cl. H04L 9/00

(52) U.S. Cl. 713/153

(57) ABSTRACT

A secured message indicates that a node (104) in a network (102) is operating correctly and detecting that the node is compromised such that a device (106) should not communicate with the node. When the node is detected to be compromised, the secured message ceases to be transmitted to the node and the device. The secured message may include a time stamp portion and a security portion. A secured timestamp server (110) includes a transceiver (202) that receives notifications from a network management server (108) and transmits secured messages for use by the device. A processor (204) provides the secured message with a time stamp portion and a security portion when notifications indicate a node in the network is properly operating and ceases the transmission of the secured message when notifications indicate that the node is compromised.

### FIELD OF THE INVENTION

The present invention relates generally to method and apparatus for detecting that a node in a network is comprised and, in particular for enabling a mobile device to be notified that a base station is compromised and that the mobile device should no longer communicate with the base station.

### BACKGROUND

Networks, including wired communication and wireless communication networks, are provided with systems that monitor the network and the various components within the network to determine if those components are operating properly. One such monitoring system is a network monitoring system that is provided as a part of wireless communication network. The network monitoring system operates as a part of a network and detects abnormal conditions in the network and on network components that may affect performance. Some of these abnormal conditions may prevent communications altogether or components may be compromised in such a way that communications are not performed according to communication standards, operator expectations or consumer expectations.

For example, a network component, such as a base station, may be compromised by a nefarious means. A hacker may gain access to the base station and change parameters on which the base station operates that jeopardize encrypted communications but allow the wireless communications to continue between the mobile station and the base station. When the network monitoring system detects the compromised base station, alarms can be sent to the network operator as well as other network components. The network operator and network components are able to respond to the fact that the base station is compromised in an appropriate manner including ceasing communications with the base station or disconnecting from the base station.

Mobile stations, however, may not necessarily be able to respond appropriately when a base station is compromised for any reason. Mobile stations' primary or sole access point to a communication network is through the base station. Thus, the mobile station must rely on the base station to receive communications that an aspect of the communication network, including the base station that it is connected to, is compromised. Moreover, the base station can be compromised in such a way that the network operator and other network components are aware that the base station is compromised but those components are not able to inform the mobile station to cease communicating with the base station.

According to the prior art, mobile stations can be notified of issues with base stations by being directly connected with the network management server. Such connection can be made using Internet Protocol. This method of informing mobile station, however, does not operate when the mobile station is in idle mode. Furthermore, such communications also necessarily goes through the base station which is the mobile station's sole point of access to the network. This gives the compromised base station the possibility of tampering with all communications to the mobile station, so that the mobile station will remain unaware that the network no longer trusts the base station.

In view of the foregoing, there is a need to allow mobile stations to detect whether the base station that the mobile stations are connected to has been detected to be compromised by the network and is no longer trusted by the network. In order to handle the situation where the mobile station is in the idle mode, there is a need to notify the mobile station of comprised base stations that does not require a direct active connection to the network management server.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a block diagram of a communication network operating in accordance with some embodiments of the invention.

FIG. 2 is a block diagram of a timestamp server operating in accordance with the some embodiments of the invention.

FIG. 3 is a flow diagram of the operation of the network and timestamp server in accordance with some embodiments of the invention.

FIG. 4 is a flow diagram of the operation of a mobile station in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to enabling a mobile station to detect or be informed that the base station serving the mobile station is compromised. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of enabling a mobile station to detect or be informed that the base station serving the mobile station is compromised. The non-processor circuits may include, but are not limited to, a radio receiver, a radio transmitter, signal drivers, clock circuits, power source circuits, and user input devices. As such, these functions may be interpreted as steps of a method to enable a mobile station to detect or be informed that the base station serving the mobile station is compromised. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In an embodiment, the present invention is directed to transmitting a secured message to indicate that a node in a network, such as a base station, is operating correctly and detecting that the node is compromised so that the node is not operating properly and a device, such as a mobile station, should not communicate with the node. When the node is detected to be compromised and not operating properly, the method continues by ceasing to transmit the secured message to the node and the device. The secured message may include a time stamp portion and a security portion. The security portion can enable the device to confirm that the secured message originates for its intended source such as a network management server or a secured timestamp server. In an embodiment, the security portion is constructed by the network management server using a private key, and the device can verify the authenticity of the message using a public key corresponding to the private key. As is understood, the source is external from the node that is communicating with the device. In an embodiment, the time stamp can be one of a counter or a real time clock. Moreover, the present invention can include a step of synchronizing the device to a server wherein the secured message originates from the server. The time stamp that is a part of the secured message can be used to synchronize the secured message between the server and the device. In addition, the secured message is transmitted from a server to the node, and the node transmits the secured message to the device. The device can use a local clock to verify the secured message.

In another embodiment of the present invention, a method is provided where a device receives a message from a node. The message is provided to the node by an external source to notify the device that the node is operating properly and has not been compromised. The device verifies that the message is a secured message that should be received by the node from an external source to indicate that the node has not been compromised and is operating properly. When the device detects that the message is a not a secured message or the device does not receive the message from the node, the device interrupts communications with the node such that the device takes into account that the node is compromised and not operating properly. In an embodiment, the device ceases to communicate with the node. In another embodiment, the device pauses sending messages until it receives more data regarding the condition of the node, until a timer expires or sends only messages that can be sent regardless of the condition of the node. The device can initiate communications with another node that provides the mobile station with a secured message. The device can also synchronize itself with the external source using a time stamp portion of the secured message or by other means. In an embodiment, the external source is a secured timestamp server that operates in the communication network and in conjunction with a network management server that monitors the performance of the network components such as the node or base station.

The present invention also includes a secured timestamp server that can operate as a part of or separate from the network management server. The secured timestamp server can include a transceiver that receives notifications from a network management server, which monitors the network, and transmits secured messages for use by a device, such as the mobile station, that is operating on a network. The secured timestamp server may also include a processor that is coupled to the transceiver. The processor is configured to provide the secured message with a time stamp portion and a security portion when notifications indicate that one of plurality nodes in the network is properly operating. The processor is also configured to cease or stop having the secured message be transmitted by the transceiver when the notifications indicate that the one of the plurality of nodes is compromised and not operating properly. In an embodiment, the secured timestamp server generates a separate and distinct secured message for each of the plurality of nodes so that each node has a unique and individualized secured message.

The time stamp portion can be used to synchronize the secured timestamp server to the device. The secured message can be transmitted by the transceiver as a broadcast message to the plurality of nodes or mobile stations that are operating in the network. The processor can also provide a public key portion to be used by the device while in conjunction with a private key portion that is provided as at least a part of the security portion of the secured message. The secured timestamp server can also transmit the secured messages to a plurality of nodes operating within the network so that the nodes transmit the secured messages to the mobile stations devices communicating with the plurality of nodes.

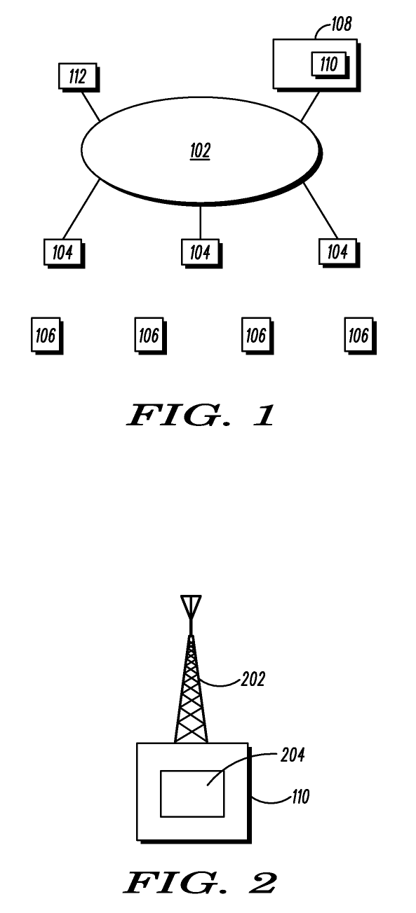

Turning to FIG. 1, a wireless communication system 100 is shown. The present invention is designed to operate as a part of a wireless communication network such as a Code Division Multiple Access (CDMA) network, Global System of Mobile Communication (GSM) network, CDMA2000 network, Wideband CDMA (W-CDMA) network, Universal Mobile Telecommunication System (UMTS) network, Orthogonal Frequency Division Multiplexing (OFDM) network and networks using other protocols. It is also understood to operate with any sort of communication network and other networks where nodes can be compromised. As seen, the system 100 includes an Internet Protocol (IP) network 102, which includes various infrastructure components (not shown) to operate the system 100. The system also includes a plurality of base stations, or nodes, 104 that provide access to the network 102 for a plurality of mobile stations 106. The mobile stations can be a cellular phone, pager, notebook computer, personal digital assistant or other type of wireless or wired communication device. As is understood, each of the plurality of base station 104 provide signals and messages to each of the mobile stations 106 that are located in the area serviced by the base station.

The system 100 also includes a network management server 108. The network management server 108 performs various management services for the system 100 and the network 102. The network management server 108 is used by the network operator to, among other things, monitor the network 102, base stations 104 and other components for issues that arise across the system 100 and to ensure that the components are operating properly. Such issues may compromise the integrity of the system 100 and may compromise or jeopardize the ability of a mobile station 106 to properly communicate with a base station 104. The network management server 108 is capable of sending alarms to the network operator and network components when various conditions are detected throughout the system and on network components.

In addition, the network management server 108 can send notifications to various components within the system 100 and the network 102 when alarm conditions are detected. These alarm notifications can be used by the system and network components to accommodate changing conditions. For example, a network component can divert messages and signals around a particular component if an alarm notification indicates that another component has lost power. In the case of an alarm condition being detected at a particular base station 104, the network management server 108 can send messages to other network components and base stations to divert messages to different base stations 104.

Messages and signals from the network management server 108 can be responded to by network components and other base stations, but it may be difficult for mobile stations 106 to receive alarm notifications when the mobile station 106 is connected to the base station 104 in which the alarm condition has been detected. Often, one base station 104 is the only connection a mobile station 106 has with the system 100 and the network 102. In certain circumstances, the parameters of a base station 104 can be altered such that a network management server detects an alarm condition, but the mobile stations 106 that operate using the compromised base station 104 can not be notified and those mobile stations 106 will continue to transmit and receive messages with the base station 104 as if the base station 104 is not compromised. This situation can present issues for the system 100, the network operator and the mobile station 106.

To inform the mobile stations 106 that are transmitting and receiving messages with a compromised base station 104, the present invention includes a server 110 such as a secured timestamp server. As seen, the secured timestamp server is external to the base station so as to provide a source separate from the base station to indicate to a mobile station that the base station is compromised and not operating properly when the only access to the network is through that base station. In an embodiment, the secured timestamp server 110 is a module or process that is a part of the network management server 108. In another embodiment, the secured timestamp server is a stand alone server that is another network component within the system 100 and network 102. Alternatively, the secured timestamp server 110 can be a part of another network component such as an authentication, authorization and accounting (AAA) server 112.

In FIG. 2, a block diagram of the secured timestamp server 110 is shown. The secured timestamp server 110 can include a transceiver 202 that transmits and receives messages and signals with other components within the system 100 including the network management server 108, the AAA server 112 and base stations 104. In an embodiment, the transceiver 202 receives messages sent by the network management server 110 that indicates that a network component including a base station 104 has been compromised and is not operating according to communication standards or operator expectations. The transceiver 202 also transmits messages to base stations 104, which in turn can transmit the messages to mobile stations 106. These messages, which are described in more detail below, can indicate to the mobile stations 106 that the base station to which the mobile stations 106 are connected is operating in accordance with communication standards or operator expectations. Thus, the mobile stations 106 can be assured that the base station 104 has not been compromised.

The secured timestamp server 110 also includes a processor 204 that is coupled to the transceiver 202. The processor 204 processes the messages that the transceiver 202 receives from the network management server 110 and the messages that are transmitted to base stations 104 for use by the mobile stations 106. In accordance with the principles of the present invention, the processor 204 processes messages that are transmitted to the base stations 104 where the messages indicate to the mobile stations 106 that the base station 104 to which the mobile station 106 is connected to has not been compromised. When a mobile station 106 ceases to receive these messages and signals that originate from the secured timestamp server 110, the mobile station 106 therefore is notified that the base station 106 to which it is connected has been compromised and that the mobile station cannot rely on the accurate communications with that base station. The mobile station 106 can therefore terminate its connection to that base station 104 and reroute its messages to another base station 104. Alternatively, the mobile station 106 determines that the base station is compromised if the mobile station cannot verify that a message received from the base station is a secured message transmitted by the secured timestamp server 110.

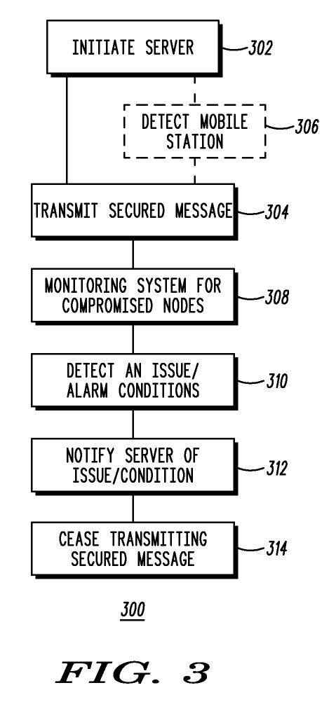

FIG. 3 is a flow chart 300 of the operation of a secured timestamp server 110 in accordance with the principles of the present invention. First, the secured timestamp server 110 is initialized 302 with network data including the number of base stations that operating in the system 100, the location of the base stations operating within the system 100 and each of the base stations' identifications. If the base station 104 is known by the secured timestamp server 110 to be operating according to communication standards and operator expectations, the secured timestamp server 110 begins to transmit 304 a message to be received by the base station 104 and the mobile station 106. The secured timestamp server 110 generates distinct secured messages such that each of the base station receives a secured message that is unique and individualized. The secured timestamp server 110 does not wait to see communications being conducted with the mobile station 104 but continually issues messages to the base stations for transmittal to the mobile stations as long as the base stations is operating according communication standards or operator expectations. In this scenario, the messages are sent regardless of whether the mobile stations are communicating with the base station. In an alternative embodiment, the secured timestamp server 110 then detects 306 when mobile station 106 begins to transmit and receive signals and messages with a base station 104. The secured timestamp server can detect when the mobile station is in either the idle mode or the active mode. In an embodiment, this occurs when a the mobile station 106 initiates a call to another mobile station or communication device or when signals and messages are being sent to the mobile station because another mobile station or communication device is trying to connect to the mobile station 106. In another embodiment, the mobile station is recognized when it begins receiving and responding to broadcast messages sent by a base station 104.

The messages that are sent to the base stations 104 by the secured timestamp server 110 are secured messages. In one embodiment of the invention, these secured messages can be sent at given and known intervals. The secured messages include a timestamp portion and a security portion. The timestamp portion indicates the time at which the secured timestamp server 110 issued the secured message. The timestamp portion can be any sort of mechanism to monitor time and can be a real time clock, a counter that increases in value at a steady and predictable manner, a global positioning service (GPS) signal or other time keeping mechanisms. The security portion can be any sort of security mechanism such as a public/private key type arrangement. In this arrangement, the mobile stations 106 are provided with public key portions that will operate with designated private keys that are known only to the secured timestamp server. The security portion of the secured message is constructed by the secured timestamp server using the private key. When the secured message is received by the mobile station 106 by way of the base station 102, the mobile station 106 uses the public key corresponding to the private key to verify that the message is from the secured timestamp server 110 and that the base station 104 is operating according to communication standards and operator expectations. Other security configurations can be used for the security portion and for the secured timestamp server 110, the network management server 108, the base stations 104 and mobile stations 106.

While the secured timestamp server 110 is transmitting secured messages to the base stations 104 for use by the mobile stations connected to those base stations, the network management server 108 is monitoring 308 the system 100 and network 102 conditions. The network management server 108 can detect 310 when an issue arises with one of the base stations 104 such that that base station 104 is compromised and continuing communication with that base station will not meet with various communication standards or operator expectations. Other network components can detect 310 alarm conditions throughout the network and in particular with base stations 104.

The network management server 108 notifies 312 the secured timestamp server 110 with an alarm condition to indicate that a base station 104 has been compromised. As is understood, a base station 104 is can be compromised for any of a number of reasons. When the secured timestamp server is notified of the compromised base station 104, the server 110 ceases to send the compromised base station 104 the secured message. Other network operations may continue without any disruption. Accordingly, the secured timestamp server 110 continues to issue secured messages for other base stations 104 operating within the system 100 and other standard network operations continue. In addition, the compromised base station may continue to operate in a compromised manner or other steps may be taken to address the alarm condition that has been detected. When the mobile station 106 ceases to receive the secured message, it understands that the base station to which it is connected has been compromised. In an embodiment, the network management server 108 will be notified when the affected base station 104 is properly operating, and the secured timestamp server 110 will once again send secured messages to the base station 104.

According to this description, the secured messages are sent from the base station 104 to the mobile station 106. In an embodiment, the secured messages are sent as a broadcast message so that the mobile station is notified of the status of the base station when the mobile station is in both the idle mode and the active mode. When the mobile station is in the idle mode and does not receive a secured message, the mobile station 106 will not initiate communication with that base station nor will it respond to a request for a channel from that base station. When the mobile station is in the active mode and the secured message is not received, the mobile station will cease the active communication with that base station 104. Alternatively, the mobile station may interrupt the active communication with the base station and may resume communications after a given time interval or after receiving further data regarding the condition of the base station.

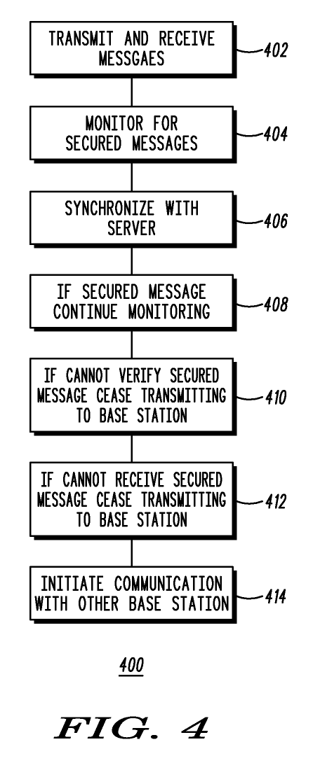

FIG. 4 is a flow chart of the operation of a mobile station 106 that operates in a system 100 that includes the secured timestamp server 110 in accordance with the principles of the present invention. The following description is for the case of mobile stations in active mode, but a similar procedure would also apply for mobile stations in idle mode. The process begins with the mobile station 106 transmitting and receiving 402 messages with base station 104 serving the location in which the mobile station is operating. The mobile station 106 can be initiating communication to another communication device or receiving a call or communication aimed at the mobile station. As a part of the received messages, the mobile station monitors 404 for a secured message that is originated by the secured timestamp server 110. As understood, the secured message is sent at a given interval and includes the timestamp portion and the security portion. Thus, the mobile station uses its own internal clock to monitor 404 for the secured message.

In an embodiment, the mobile station 106 can synchronize 406 with the secured timestamp server 110. The synchronization can occur by the mobile station using a trusted clock. The trusted clock originate from the system 100, the network 102 such as from the AAA server 112, or be the mobile station's own internal clock. The mobile station and the secured timestamp server are synchronized in order for the mobile station to monitor for the secured messages at the interval set by the server 110.

Upon receipt of the various messages that a mobile station 106 receives from a base station 104, the mobile station 106 will verify that a message received from the base station 104 is a secure message. In an embodiment, the mobile station 106 will use the public key it has received to verify the message is the secured message. As is known, the public key operates with the private key that is a part of the security portion of a secured message. In addition, the mobile station may use the timestamp portion of the secured message to verify that the received message is a secured message sent by the secured timestamp server 110. In an embodiment where the timestamp portion is a counter, the mobile station will verify that the counter value received in the secured message matches the counter value kept by the mobile station. In another embodiment, the time from the internal clock of the mobile station 106 can be verified to correspond with the timestamp in the secured message generated by the secured timestamp server 100, which may be synchronized as described.

It may be noted that the mobile station 106 verifies that the received message is a secured message by comparing the timestamp or counter or equivalent indication in the received message with an internal clock or counter. Accordingly, the mobile station's internal clock or counter must be synchronized with the timestamp or counter being used by the secured timestamp server 110. For example, a compromised base station may, after the secured timestamp server has stopped issuing secured messages to it, try to replay an old message that was previously issued prior to the compromise. The synchronization procedure 406 provides the mobile station with a trusted reference alignment that will detect such malicious replay of messages by a compromised base station. In cases where the mobile station 106 has access to a trusted clock source that is known to be synchronized with the secured timestamp server 110, the synchronization step 406 may be omitted.

If the mobile station verifies that the message received at the interval is a secured message, the mobile station 106 continues to transmit and receive 408 messages with the base station for normal communications. On the other hand, the mobile station 106 may determine that the message is not a secured message because the timestamp portion or the security portion of the message does not correspond to the expected values. If the mobile station cannot verify the secured message, the mobile station 106 will cease to transmit and receive 410 messages from the base station because the mobile station understands that the base station has been compromised and that the mobile station can no longer safely rely on the communications with that base station. Alternatively, the mobile station 106 may not receive a message from the base station at a given interval. This may be determined by not being able to verify a message with a timestamp that corresponds to expected timestamp of a counter or the synchronized clock or not being about to verify the security portion of the secured message using a public/private key configuration or other security arrangement. If no secured message is received, the mobile station will also cease transmit and receive 412 messages from the base station because it is understood that the secured timestamp server 110 received an alarm condition from a network management server or elsewhere and did not send the secured message at the given interval. In an alternative embodiment, the mobile station 106 may interrupt the communications between the mobile station and the base station 104. Accordingly, the mobile station may pause sending messages for a given interval and resume sending messages after the interval expires or after it receives further data regarding the condition of the base station 106. The communications between the mobile station and the base station can also be interrupted by altering the type of messages being transmitted by the mobile station where those messages can be received by the base station in the compromised state.

In the event the mobile station ceases to transmit and receive messages with the base station 104, the communication with the other device may be terminated. In an embodiment, the mobile station 106 may attempt to initiate communication 414 with another base station that services the area in which the mobile station is operating. Alternatively, the network management server 110 may send a message to another base station 104 to initiate communication with the affected mobile station 106.

As can be appreciated from the above description, the secured timestamp server 110 operates within the system 100 to ensure that a mobile station can detect when a base station to which it is communicating is compromised for any reason. The server 110 transmits the secured messages at a given interval, and the messages are received by the base station, which in turn transmits the secured messages to the mobile stations. The mobile stations will continue normal communications with the base station as long as they receive the secured messages at the given intervals, and that they can verify that the messages received at the given intervals are secured messages. The secured messages can be verified by using the security portion or the timestamp portion. If no secured message is received at a given interval or a message at the given interval cannot be verified as a secured message, the mobile station ceases transmitting and receiving messages with that base station. Thus, the secured timestamp server 110 is providing continuous proof of a base station's worthiness from an external source while the mobile station relies only on being connected to that base station 104. When the base station 104 does not send the secured message from the external source, the mobile station 106 detects that the base station is compromised without relying on another connection to the system 100 or the network 102.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising:
transmitting a secured message to indicate that a node in a network is operating correctly;
detecting that the node is compromised such that a device should not communicate with the node;
ceasing to transmit the secured message when the node is detected to not be working properly.

2. The method of claim 1 wherein the secured message comprises a time stamp portion and a security portion.

3. The method of claim 2 wherein the security portion is used to confirm that the secured message originates from a secured source.

4. The method of claim 3 wherein the security portion comprises a first key and wherein a second key is used with the first key to confirm that the secured message originates from a secured source.

5. The method of claim 2 wherein the time stamp is one of a counter or a real time clock.

6. The method of claim 1 further comprising synchronizing the device to a server wherein the secured message originates from the server.

7. The method of claim 6 wherein synchronizing the device to the server comprises providing a clock reference to the device wherein the device uses the clock reference to align to the timestamp.

8. The method of claim 1 wherein the secured message is transmitted from a server to the node and wherein the node transmits the secured message to the device.

9. The method of claim 1 wherein transmitting a secured message further comprising transmitting a plurality of secured messages to indicate that the node in the network is operating correctly wherein each of the plurality of secured messages is transmitted at a predetermined interval.

10. A method comprising:
receiving at a device a message from a node;
verifying that the message is a secured message received by the node from an external source to indicate that the node has not been compromised;
interrupting communications with the node when one of (a) the device detects that the message is a not a secured message and (b) the device does not receive the message from the node within a specified interval.

11. The method of claim 10 wherein the secured message includes a time stamp portion and a security portion.

12. The method of claim 11 wherein the time stamp portion comprises one of a counter or a real time clock.

13. The method of claim 10 further comprising synchronizing the device with the external source.

14. The method of claim 13 wherein synchronizing the device to the external device comprises providing a clock reference to the device wherein the device uses the clock reference to align to the timestamp.

15. The method of claim 10 wherein the device includes a local clock to verify that the message is the secure message from the external source.

16. An apparatus comprising:
a transceiver for receiving notifications from a source and transmitting secured messages for use by a device operating on a network;
a processor coupled to the transceiver wherein the processor is configured to provide the secured message with a time stamp portion and a security portion when notifications indicate that a node in the network is properly operating and ceases to have the secured message be transmitted by the transceiver when the notifications indicate that the node is not operating properly.

17. The apparatus of claim 16 wherein the processor is further configured to synchronize the apparatus to the device.

18. The apparatus of claim 16 wherein a distinct secured message is sent by the transceiver to each of the plurality of nodes in the network.

19. The apparatus of claim 16 wherein the processor provides the security portion of the secured message by using a key accessible only to the apparatus.

20. The apparatus of claim 16 wherein the notifications are generated by source external from the node.
